(19) United States
(12) Patent Application Publication
(10) Pub. No.: US 2013/0011150 A1
(43) Pub. Date: Jan. 10, 2013

(54) IMAGE FORMING APPARATUS AND CONTROL METHOD THEREOF

(75) Inventors: Myeong Seok Lee, Seongnam-si (KR); Hwa Chul Choi, Suwon-si (KR)

(73) Assignee: Samsung Electronics Co., Ltd, Suwon-si (KR)

(21) Appl. No.: 13/542,788

(22) Filed: Jul. 6, 2012

(30) Foreign Application Priority Data
Jul. 6, 2011 (KR) 10-2011-0066878

(51) Int. Cl. G03G 15/00

(52) U.S. Cl. 399/43; 399/44

(57) ABSTRACT

An image forming apparatus includes an operation progressing condition that is considered when the image forming apparatus enters an apparatus protection mode. Further, a method of controlling the image forming apparatus includes receiving an apparatus protection mode entry condition of the image forming apparatus, detecting the temperature of the image forming apparatus or the number of continuously printed sheets, judging whether or not the apparatus protection mode entry condition is satisfied, if the temperature of the image forming apparatus is higher than a predetermined temperature or the number of continuously printed sheets is greater than the predetermined number of sheets, and maintaining a basic printing operation of the image forming apparatus, if the apparatus protection mode entry condition is not satisfied, thereby increasing user's satisfaction and operation efficiency.

### CROSS-REFERENCE TO RELATED APPLICATIONS

This application claims priority under 35 U.S.C. §119(a) from Korean Patent Application No. 2011-0066878, filed on Jul. 6, 2011 in the Korean Intellectual Property Office, the disclosure of which is incorporated herein by reference.

### BACKGROUND

1. Field of the General Inventive Concept

The general inventive concept relates to an image forming apparatus that reduces over-heating thereof.

2. Description of the Related Art

In general, image forming apparatuses are apparatuses which form an image on recording media, and correspond to printers, photocopiers, facsimile machines, and multi-functional devices embodying combined functions thereof.

Here, an image forming apparatus using toners is configured to transfer the toners to a recording medium and to fix the toners to the recording medium to obtain a desired image. Such a procedure is referred to as electrophotography.

Electrophotography includes charging, exposure, development, transfer and fusing processes. The charging process is a process of electrically charging photoconductors by a charger to form uniform electric charges on photoconductive drums. The development process is a process of attaching developers to electrostatic latent images formed on the photoconductors to convert the electrostatic latent images into visible images. The transfer process is a process of transferring the developers attached to the photoconductors to a recording medium through a transfer device. The fusing process is a process of applying high temperature and high pressure to the recording medium having passed through the transfer process to fuse the developers on the recording medium.

If a large amount of work including a large number of pages is processed during the above-described electrophotography, the internal temperature of the image forming apparatus is raised, and when the internal temperature is raised to a designated temperature or more, durability and lifespan of the image forming apparatus may be lowered. In order to solve these problems, the image forming apparatus is provided with an apparatus protection mode. The apparatus protection mode is a mode in which, the image forming apparatus enters a cooling mode to prevent rise of the internal temperature of the image forming apparatus. However, the conventional apparatus protection mode is operated even when a small number of pages to be completed remains, and thus has a drawback of preventing an ideal temperature throughout the entire image forming apparatus.

### SUMMARY OF THE INVENTIVE CONCEPT

Additional features and utilities of the present general inventive concept will be set forth in part in the description which follows and, in part, will be obvious from the description, or may be learned by practice of the general inventive concept.

Additional features of the present general inventive concept will be set forth in part in the description which follows and, in part, will be obvious from the description, or may be learned by practice of the present general inventive concept.

In accordance with one feature of the present general inventive concept, an image forming apparatus includes an input unit to receive an apparatus protection mode entry condition of the image forming apparatus, a temperature sensing unit to detect the temperature of the image forming apparatus, a printed sheet count unit to count the number of continuously printed sheets, and a control unit to judge whether or not the apparatus protection mode entry condition is satisfied, if the temperature of the image forming apparatus is higher than a predetermined temperature or the number of continuously printed sheets is greater than the predetermined number of sheets, and to maintain a basic printing operation of the image forming apparatus, if the apparatus protection mode entry condition is not satisfied.

The input unit may receive the reference number of sheets of recording media which is compared with the number of remaining sheets of the recording media, as the apparatus protection mode entry condition.

The control unit may judge whether or not the apparatus protection mode entry condition is satisfied by comparing the number of remaining sheets of the recording media with the reference number of sheets of the recording media received by the input unit, if the temperature of the image forming apparatus is higher than the predetermined temperature or the number of continuously printed sheets is greater than the predetermined number of sheets.

The temperature sensing unit may sense the temperature of a random component provided within the image forming apparatus.

The image forming apparatus may further include an operation environment detection unit to detect operation environment including operation temperature and operation humidity information of the image forming apparatus.

The control unit may determine a point of time when whether or not entry into an apparatus protection mode is determined according to the temperature of the image forming apparatus and the operation environment.

The control unit may allow the image forming apparatus to enter an apparatus protection mode, if the temperature of the image forming apparatus is higher than the predetermined temperature or the number of continuously printed sheets is greater than the predetermined number of sheets, and the apparatus protection mode entry condition is satisfied.

The control unit may reduce a printing velocity of the recording media, widen a feed interval of the recording media, or stop printing of the recording media and then re-execute printing of the recording media after a designated time, if the image forming apparatus enters the apparatus protection mode.

In accordance with another feature of the present general inventive concept, a control method of an image forming apparatus includes receiving an apparatus protection mode entry condition of the image forming apparatus, detecting the temperature of the image forming apparatus or the number of continuously printed sheets, judging whether or not the apparatus protection mode entry condition is satisfied, if the temperature of the image forming apparatus is higher than a predetermined temperature or the number of continuously printed sheets is greater than the predetermined number of sheets, and maintaining a basic printing operation of the image forming apparatus, if the apparatus protection mode entry condition is not satisfied.

The receipt of the apparatus protection mode entry condition may include receiving the reference number of sheets of recording media which is compared with the number of remaining sheets of the recording media when whether or not entry into an apparatus protection mode is judged.

Whether or not the apparatus protection mode entry condition is satisfied may be judged by comparing the number of remaining sheets of the recording media with the reference number of sheets of the recording media received as the apparatus protection mode entry condition by the input unit at a point of time when the temperature of the image forming apparatus is higher than the predetermined temperature or the number of continuously printed sheets is greater than the predetermined number of sheets.

The control method may further include detecting operation environment including operation temperature information of the image forming apparatus.

A point of time when whether or not the apparatus protection mode entry condition is satisfied is judged may be delayed, if the temperature of the image forming apparatus is higher than the predetermined temperature or the number of continuously printed sheets is greater than the predetermined number of sheets, and the operation temperature is lower than a predetermined temperature.

The point of time when whether or not the apparatus protection mode entry condition is satisfied is judged may be advanced, if the temperature of the image forming apparatus is lower than the predetermined temperature or the number of continuously printed sheets is smaller than the predetermined number of sheets, and the operation temperature is higher than a predetermined temperature.

The image forming apparatus may enter an apparatus protection mode, if the temperature of the image forming apparatus is higher than the predetermined temperature or the number of continuously printed sheets is greater than the predetermined number of sheets, and the apparatus protection mode entry condition is satisfied.

A printing velocity of the recording media may be reduced, a feed interval of the recording media may be widened, or the printing operation of the recording media may be stopped and then re-executed after a designated time, if the image forming apparatus enters the apparatus protection mode.

In another feature of the present general inventive concept, an image forming apparatus to output printed media comprises a temperature sensing unit to detect a temperature of the image forming apparatus, a printed count unit to determine a number of continuously printed media, and a control unit to determine existence of a protection mode condition, and to initiate a protection mode that cools the image forming apparatus when the protection mode condition exists.

In yet another feature of the present general inventive concept, an image forming apparatus to generate printed medium having images formed thereon comprising a printed count unit to determine a number of completed printed medium continuously output from the image forming apparatus, and a control unit to determine an amount of remaining medium awaiting printing based on the number of completed printed medium, and to initiate a protection mode that prevents overheating of the image forming apparatus based on the amount of remaining medium.

In still another feature of the present general inventive concept, an image forming apparatus comprises a transfer unit that drives a transfer belt at a driving velocity, a temperature sensing unit to detect a temperature of the image forming apparatus, a printed count unit to determine a number of continuously printed media, a control unit in electrical communication with the transfer unit, the temperature sensing unit and the printed count unit to determine an apparatus protection condition and to selectively operate the image forming apparatus in a normal mode and a protection mode based on the apparatus protection condition, the transfer unit driving the transfer belt at a first driving velocity during the normal mode and a second driving velocity that is slower than the first driving velocity during the protection mode.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 is a view schematically illustrating an electrophotographic image forming apparatus in accordance with one exemplary embodiment of the present general inventive concept;

FIG. 2 is a block diagram of a control system of the image forming apparatus in accordance with the exemplary embodiment of the present general inventive concept;

FIG. 3 is a graph illustrating relations between a resistance value of transfer rollers provided on the image forming apparatus in accordance with the exemplary embodiment of the present general inventive concept and operation environment;

FIG. 4 is a perspective view illustrating a fusing device provided on the image forming apparatus in accordance with the exemplary embodiment of the present general inventive concept and a temperature sensing unit attached to the fusing device;

FIGS. 5A and 5B are graphs illustrating adjustment of a printing velocity and a recording medium feed interval of an image forming apparatus in accordance with one exemplary embodiment of the present general inventive concept when the image forming apparatus enters an apparatus protection mode;

FIGS. 6A and 6B are graphs illustrating adjustment of a printing velocity and a recording medium feed interval of an image forming apparatus in accordance with another exemplary embodiment of the present general inventive concept when the image forming apparatus enters the apparatus protection mode;

FIG. 7 is a graph illustrating adjustment of a printing velocity of an image forming apparatus in accordance with another exemplary embodiment of the present general inventive concept when the image forming apparatus enters the apparatus protection mode;

FIGS. 8A and 8B are graphs illustrating no adjustment of the printing velocity and the recording medium feed interval of the image forming apparatus in accordance with one exemplary embodiment of the present general inventive concept when the image forming apparatus does not enter the apparatus protection mode;

FIGS. 9A and 9B are graphs illustrating no adjustment of the printing velocity and the recording medium feed interval of the image forming apparatus in accordance with another exemplary embodiment of the present general inventive concept when the image forming apparatus does not enter the apparatus protection mode;

FIG. 10 is a graph illustrating no adjustment of the printing velocity of the image forming apparatus in accordance with another exemplary embodiment of the present general inventive concept when the image forming apparatus does not enter the apparatus protection mode;

FIG. 11 is a view illustrating a user interface screen provided on a display unit of an image forming apparatus in accordance with one exemplary embodiment of the present general inventive concept to input the apparatus protection mode;

FIG. 12 is a view illustrating setup of an apparatus protection mode entry condition through a method using connection of the image forming apparatus in accordance with the exemplary embodiment of the present general inventive concept to a host;

FIG. 13 is a flowchart illustrating a process of entering the apparatus protection mode of an image forming apparatus in accordance with one embodiment of the present general inventive concept;

FIG. 14 is a flowchart illustrating a process of entering the apparatus protection mode of an image forming apparatus in accordance with another exemplary embodiment of the present general inventive concept; and

FIG. 15 is a flowchart illustrating a process of entering the apparatus protection mode of an image forming apparatus in accordance with yet another exemplary embodiment of the present general inventive concept.

### DETAILED DESCRIPTION OF THE EXEMPLARY EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

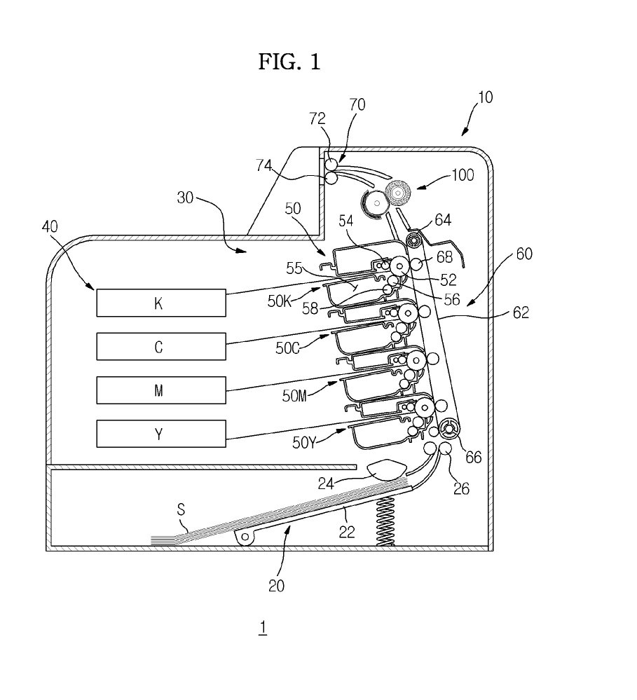

FIG. 1 is a view schematically illustrating an image forming apparatus in accordance with one exemplary embodiment of the present general inventive concept. In at least one exemplary embodiment illustrated in FIG. 1, the image forming apparatus may include an electrophotographic image forming apparatus.

Referring to FIG. 1, an electrophotographic image forming apparatus 1 in accordance with the exemplary embodiment of the present general inventive concept includes a main body 10, a recording medium feed device 20, a printing device 30, a fusing device 100, and a recording medium exit device 70.

The main body 10 forms the external appearance of the image forming apparatus 1, and supports various components installed therein. The main body 10 includes a cover (not shown) provided to open and close a part of the main body 10, and a main body frame (not shown) installed in the main body 10 to support and fix the various components.

The recording medium feed device 20 supplies recording media S to the printing device 30. The recording medium feed device 20 includes a cassette 22 on which the recording media S are loaded, and a pick-up roller 24 to convey the recording media S loaded on the cassette 21 sheet by sheet. The recording media S conveyed by the pick-up roller 24 is conveyed to the printing device 30 by a conveying roller 26.

The printing device 30 may include a light scanning device 40, a development device 50, and a transfer unit 60.

The light scanning device 40 includes a scanning optical system (not shown) and irradiates light corresponding to image information of one or more colors. For example, the irradiated light may correspond to image information of yellow Y, magenta M, cyan C and black K to the development device 50 according to a printing signal.

The development device 50 forms visible images on photoconductors 52 according to image information received from an external apparatus including, but not limited to, a computer. The image forming apparatus 1 in accordance with this exemplary embodiment is a color image forming apparatus, and thus the development device 50 includes a plurality of developers. The plurality of developers includes, but is not limited to, four developers 50Y, 50M, 50C and 50K respectively accommodating toners of different colors. The different toner colors of the developers may include, but is not limited to, yellow Y, magenta M, cyan C and black K.

Each of the developers 50Y, 50M, 50C and 50K includes a photoconductor 52, a charging roller 54, a developer storage chamber 55, a development roller 56 and a feed roller 58. The charging roller 54 charges the surface of the photoconductor 52 with a designated potential, and the light scanning device 40 irradiates light to the surface of the charged photoconductor 52 and thus forms a latent image. The developer stored in the developer storage chamber 55 is fed to the development roller 56 by the feed roller 58, and the development roller 56 feeds the developer to the latent image formed on the photoconductor 52 and thus forms a visible image.

The transfer unit 60 transfers visible images formed on the photoconductors 52 to the recording medium S. The transfer unit 60 includes a transfer belt 62 contacting the respective photoconductors 52 and driven endlessly, a transfer belt drive roller 64 to drive the transfer belt 62, a tension roller 66 to maintain tension of the transfer belt 62, and four transfer rollers 68 to transfer the visible images formed on the photoconductors 52 to the recording medium S.

The recording medium S is coupled to the transfer belt 62 and is conveyed at a velocity dictated by the driving velocity of the transfer belt 62. In at least one exemplary embodiment of the present general inventive concept, the recording medium S is conveyed at the same velocity as the driving velocity of the transfer belt 62. Accordingly, voltages, each having polarity opposite to that of each of the developers attached to the respective photoconductors 52, are applied to the respective transfer rollers 68, and thus developer images formed on the photoconductors 52 are transferred to the recording medium S.

The fusing device 100 fixes the developer images, transferred to the recording medium S by the transfer unit 60, to the recording medium S.

The recording medium exit device 70 exits the recording medium S to the outside of the main body 10. The recording medium exit device 70 includes an exit roller 72 and a pinch roller 74 installed opposite the exit roller 72.

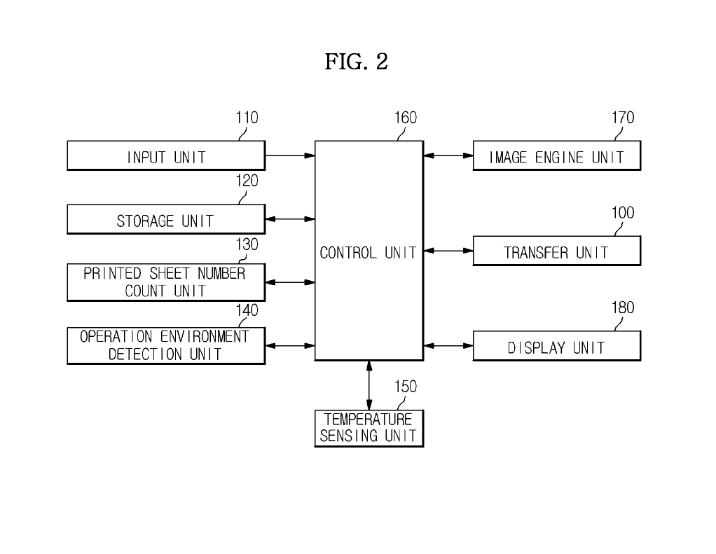

FIG. 2 is a block diagram of a control system of the image forming apparatus in accordance with the exemplary embodiment of the present general inventive concept.

The image forming apparatus 1 may include an input unit 110, a storage unit 120, a printed sheet number count unit 130, an operation environment detection unit 140, a temperature sensing unit 150, an image engine unit 170, and a display unit 180. The image forming apparatus 1 may further include a control unit 160 that operates the image forming apparatus 1 in a normal mode and a protection mode, as discussed further below. The control unit 160 is in electrical communication with each of the storage unit 120, the printed sheet number count unit 130, the operation environment detection unit 140, the temperature sensing unit 150, the image engine unit 170, and the display unit 180.

The control unit 160 may be in further electrical communication with the transfer unit 60 to control the driving velocity of the transfer belt 62. For example, the control unit 160 may output a velocity control signal that commands the transfer unit 60 to drive the transfer belt at 62 a first driving velocity during the normal mode, and a second driving velocity during the protection mode. The first driving velocity may be a high-speed velocity, whereas the second driving velocity may be a low-velocity less than the first driving velocity.

The input unit 110 receives an apparatus protection mode entry condition. The apparatus protection mode entry condition includes a condition allowing the image forming apparatus 1 to enter an apparatus protection mode. In at least one exemplary embodiment, the condition includes, but is not limited to, a number of printed sheets, a temperature of the image forming apparatus being higher than a predetermined temperature, and a reference number of sheets. The reference number of sheets may include the number of recording media compared with the number of sheets, which remains to enter the apparatus protection mode.

The input unit 110 may receive the apparatus protection mode entry condition. In at least one exemplary embodiment the apparatus protection mode entry condition is the reference number of sheets. The apparatus protection mode entry condition may be a preset by a designer and/or manufacture of the image forming apparatus, and/or may be input by a user of the image forming apparatus.

The storage unit 120 stores executing programs and various information of the image forming apparatus 1. The storage unit 120 may store the reference number of sheets input by the user. The storage unit 120 may store the maximum value (hereinafter, referred to as the “maximum number of sheets”) of the reference number of sheets, which may be input by the user. The maximum number of sheets may also be set by a designer of the image forming apparatus. The designer may set the maximum number of sheets as a margin, enough not to cause fatal damage to the image forming apparatus 1 if printing is continuously executed from a point of time when it is determined that the image forming apparatus 1 enters the apparatus protection mode based on the temperature or the number of continuously printed sheets of the image forming apparatus 1.

The storage unit 120 may also store the minimum value (hereinafter, referred to as the “minimum number of sheets”) of the reference number of sheets. The minimum value may be set by a designer of the image forming apparatus and/or may be input by the user of the image forming apparatus. The minimum number of sheets may be generally set to “0”. If the user sets the reference number of sheets to “0” under the condition that the minimum number of sheets is set to “0”, the image forming apparatus 1 enters the apparatus protection mode when other apparatus protection mode entry conditions are satisfied regardless of the reference number of sheets.

The printed sheet number count unit 130 may determine the number of sheets, which are being actually printed. In at least one exemplary embodiment of the present general inventive concept, the printed sheet number count unit 130 counts the number of driving times of the pickup roller 24 conveys the recording media. Accordingly, the number of printed sheets may be determined.

In addition, the printed sheet number count unit 130 may determine the number of continuously printed sheets. The number of continuously printed sheets means the number of printed sheets which is counted when a printing operation is continuously performed without a stopping operation, i.e., without being interrupted from printing. Omission of the stopping operation means continuous feeding of the recording media within a designated time interval.

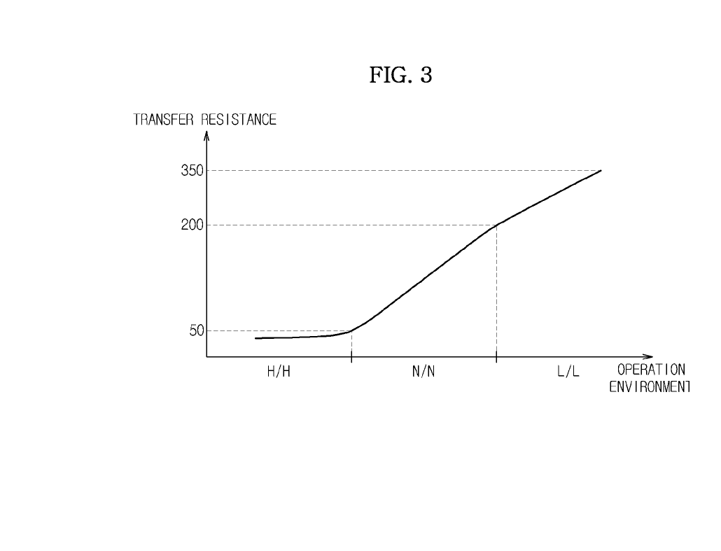

The operation environment detection unit 140 detects information regarding operation environment in which the image forming apparatus is operated. The information regarding the operation environment includes, but is not limited to, information regarding operation humidity and information regarding operation temperature. The operation environment detection unit 140 may use various methods to detect the operation environment. For example, the operation environment detection unit 140 may use a method to detect the operation environment by measuring a resistance value of the transfer rollers 68. More specifically, when the transfer roller 68 and the photoconductor 52 form nips, respectively, the operation environment detection unit 140 detects a transfer resistance indicating a magnitude of resistance between the transfer roller 68, to which designated voltage is applied, and the photoconductor 52. In more detail, when the designated voltage is applied to the transfer roller 68 after the transfer roller 68 and the photoconductor 52 form a nip with between one another, the operation environment detection unit 140 detects current flowing from the photoconductor 52 in a ground direction connected to the photoconductor 52. The operation environment detection unit 140 may detect transfer resistance by executing calculation based on Ohm's law using the designated voltage applied to the transfer roller 68 and the detected current. With reference to FIG. 3, transfer resistance has a low value of less than about 50 Ohm in an environmental section H/H having a high temperature and a high humidity, has a value of about 50 to 200 Ohm in an environmental section N/N having a normal temperature and a normal humidity, and has a value exceeding about 200 Ohm in an environmental section L/L having a low temperature and a low humidity. However, this is only exemplary and the environmental sections may be changed according to resistance values.

The operation environment detection unit 140 may allot measurable temperatures to one out of at least two sections. The operation environment detection unit 140 may distinguish the measurable temperatures into low, normal and high temperatures, and allot a detected temperature to one of the low, normal and high temperatures. In order to precisely detect the operation environment, a user may increase the number of temperature sections distinguishable by the operation environment detection unit 140. The operation environment detection unit 140 may distinguish measurable humidities into at least two sections, and allot a detected humidity to one of the at least two sections. The operation environment detection unit 140 may distinguish detected humidities into low, normal and high humidities, and allot a humidity to be detected to one of the low, normal and high humidities.

The temperature sensing unit 150 may measure a temperature of the image forming apparatus 1. The temperature of the image forming apparatus 1 may include, but is not limited to, the internal temperature of the image forming apparatus 1. The internal temperature may indicate an operating temperature of the image forming apparatus 1. As the image forming apparatus 1 operates, the internal temperature may increase.

Continuous operation of a conventional image forming apparatus may cause the image forming apparatus to over-heat, and ultimately fail. For example, operating a transfer belt at a high velocity over a continuous time period and/or operating the fusing roller over a sustained period of time may cause the internal temperature of a conventional image forming apparatus to exceed a predetermined desired temperature. Accordingly, at least one exemplary embodiment of the present general inventive concept.

In at least one exemplary embodiment of the present general inventive concept, the control unit 160 may monitor a temperature of the image forming apparatus, such as an internal temperature and/or temperature of a particular component, to prevent over-heating of the image forming apparatus 1. More specifically, the control unit 160 may be aware of a predetermined temperature value, and the temperature sensing unit 150 may measure the internal temperature of the image forming apparatus 1. The control unit 160 may receive a temperature signal from the temperature sensing unit 150 indicating the operating temperature of the image forming apparatus 1, and may compare the operating temperature to the predetermined temperature value. If the operating temperature does not exceed the predetermined temperature value, the control unit 160 may maintain the current operating state of the image forming apparatus 1. However, if the operating temperature exceeds the predetermined temperature value, the control unit 160 may initiate the apparatus protection mode to prevent the image forming apparatus 1 from over-heating, as discussed further below.

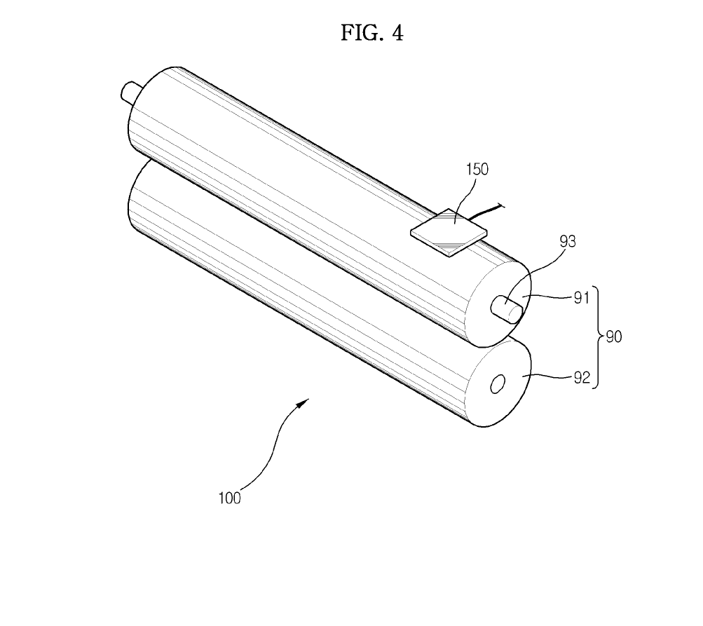

If measuring the internal temperature of the image forming apparatus 1 is desired, the temperature sensing unit 150 may be installed on one or more components of the image forming apparatus 1. For example, the temperature sensing unit 150 may sense the temperature of the fusing device 100 from among the components installed in the image forming apparatus 1. With reference to FIG. 4, the fusing device 100 includes a fixing unit 90 comprising a fusing roller 91 and a pressure roller 92 contacting fusing roller 91 to apply a designated pressure to the fusing roller 91. A heating lamp 93 to heat the fusing roller 91 is installed within the fusing roller 91. The temperature sensing unit 150 to sense the temperature of the fusing roller 91 is installed on the fusing roller 91. The temperature sensing unit 150 may sense the temperature of the fusing roller 91 and then transmit the sensed temperature to the control unit 160.

The control unit 160 determines whether or not entry into the apparatus protection mode is attempted according to the temperature information or the number of continuously printed sheets, and then confirms whether or not entry into the apparatus protection mode is attempted according to the reference number of sheets set by the user.

The control unit 160 may determine whether or not entry into the apparatus protection mode is attempted based on the temperature of the image forming apparatus 1 transmitted from the temperature sensing unit 150. The control unit 160 determines that entry into the apparatus protection mode is attempted, when the temperature of the image forming apparatus 1 is more than a predetermined and/or designated temperature. The designated temperature may be preset in the control unit 160, or may be input by a user and/or designer of the image forming apparatus 1. The temperature of the image forming apparatus 1 is sensed by the temperature sensing unit 150 installed at a position within the image forming apparatus 1. The location of the temperature sensor unit 150 may be disposed at a random location, or may disposed at a particular location that will provide a temperature reading of a particular area and/or particular component of the image forming apparatus 1. When it is confirmed that the temperature of the image forming apparatus 1 is more than the designated temperature, it may be determined that entry into the apparatus protection mode is attempted. Accordingly, the control unit 160 compares the number of remaining sheets when entry into the apparatus protection mode is attempted with the reference number of sheets, and confirms that entry into the apparatus protection mode is attempted when the number of remaining sheets is greater than the reference number of sheets.

The apparatus protection mode may employ a printing method in which a printing velocity of the image forming apparatus 1 is reduced and/or an output time interval between recording media is extended so as to cool the image forming apparatus 1, and prevent overheating.

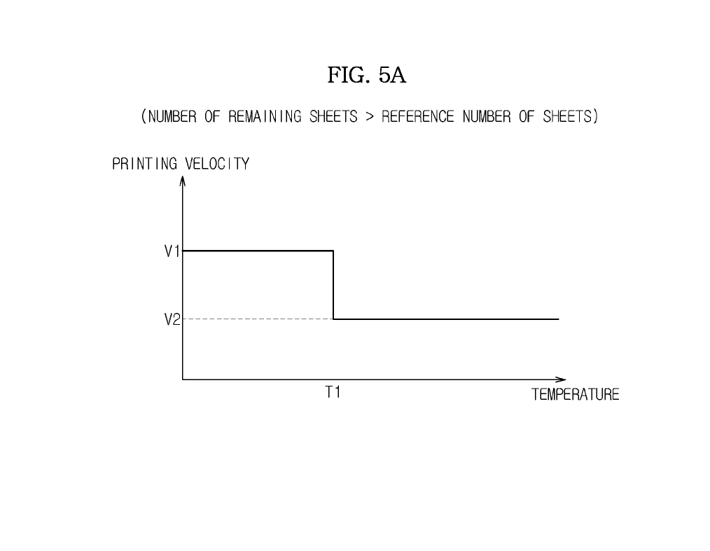

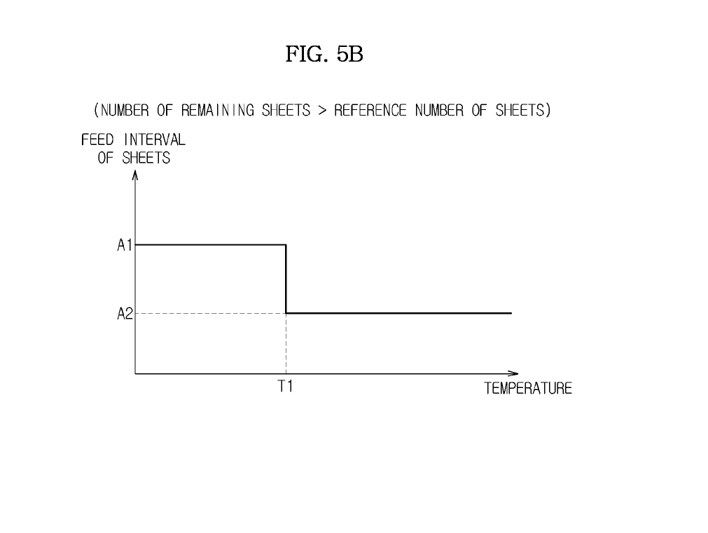

With reference to FIG. 5A, when the internal temperature of the image forming apparatus 1 is more than a designated temperature T1 and the number of remaining sheets of the recording media is greater than the reference number of sheets, the image forming apparatus 1 enters the apparatus protection mode. When the image forming apparatus 1 enters the apparatus protection mode, a printing velocity may be reduced from a first velocity V1, i.e., a high velocity, to a second velocity V2, i.e., a low velocity being a velocity less than the high velocity. In at least one exemplary embodiment, reduction of the printing velocity means reduction of a recording medium feed velocity, and the recording medium feed velocity means a time taken for a recording medium to exit the image forming apparatus 1 after entry into the image forming apparatus 1.

Referring now FIG. 5B, an operation of reducing a recording medium feed interval is illustrated. More specifically, when the internal temperature of the image forming apparatus 1 is more than the designated temperature T1 and the number of remaining sheets of the recording media is greater than the reference number of sheets, the image forming apparatus 1 enters the apparatus protection mode. When the image forming apparatus 1 enters the apparatus protection mode, a recording medium feed interval may be reduced from A1 to A2.

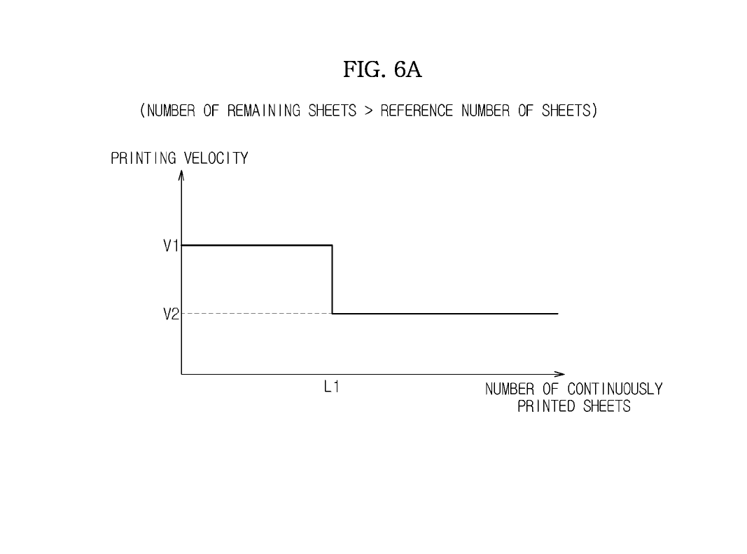

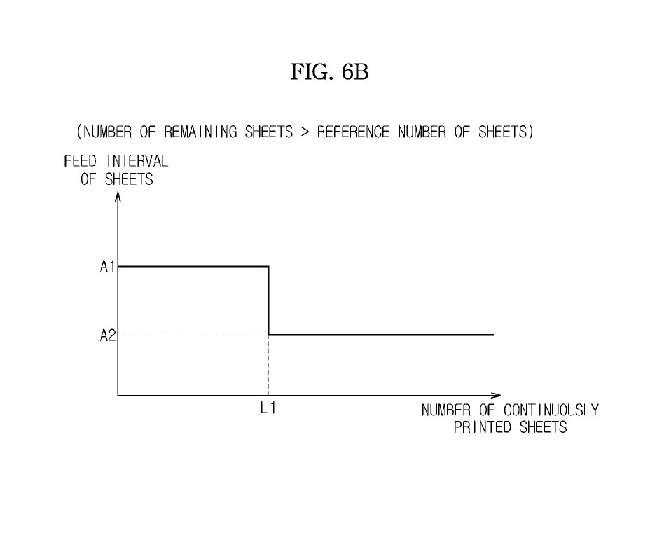

With reference to FIGS. 6A-6B, another exemplary embodiment of operating an image forming apparatus 1 is illustrated. Referring to FIG. 6A, when the number of continuously printed sheets is more than the designated number of sheets L1 and the number of remaining sheets of the recording media is greater than the reference number of sheets, the image forming apparatus 1 enters the apparatus protection mode. When the image forming apparatus 1 enters the apparatus protection mode, a printing velocity may be reduced from a high velocity V1 to a low velocity V2.

With reference to FIG. 6B, when the number of continuously printed sheets is more than the designated number of sheets L1 and the number of remaining sheets of the recording media is greater than the reference number of sheets, the image forming apparatus 1 enters the apparatus protection mode. When the image forming apparatus 1 enters the apparatus protection mode, a recording medium feed interval may be reduced from A1 to A2.

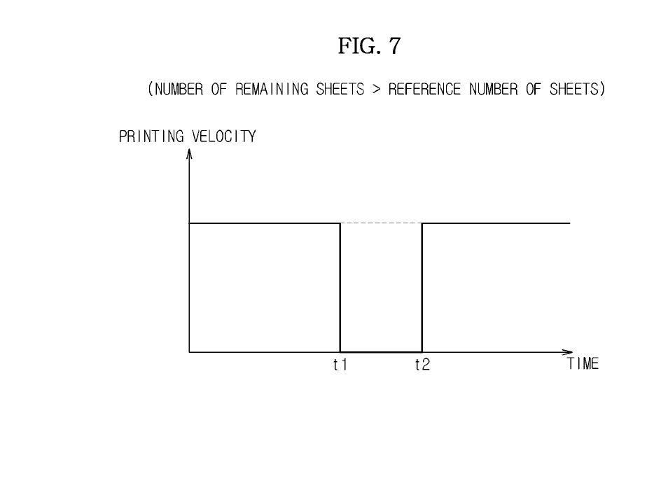

With reference to FIG. 7, another exemplary embodiment of the image forming apparatus 1 is illustrated. More specifically, when the internal temperature of the image forming apparatus 1 is more than a designated temperature or the number of continuously printed sheets is more than the designated number of sheets, and the number of remaining sheets of the recording media is greater than the reference number of sheets, the image forming apparatus 1 enters the apparatus protection mode. When the image forming apparatus 1 enters the apparatus protection mode, a recording medium feed operation is temporarily stopped (t1˜t2) and the image forming apparatus 1 enters a cooling mode such that internal temperature of the image forming apparatus may be lowered. In at least one exemplary embodiment of present general inventive concept, a cooling device may be included to expedite cooling of the image forming apparatus. For example, when the image forming apparatus 1 enters the cooling mode, operation of the fusing device 100 is stopped and a fan and the like are operated, thus lowering the internal temperature of the image forming apparatus 1.

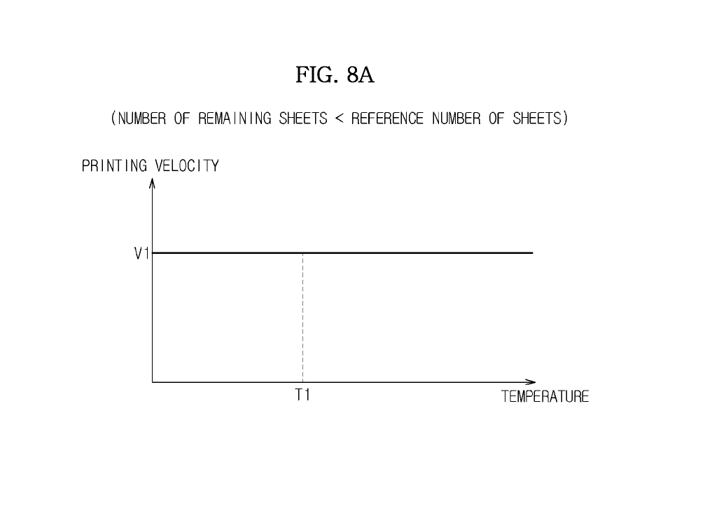

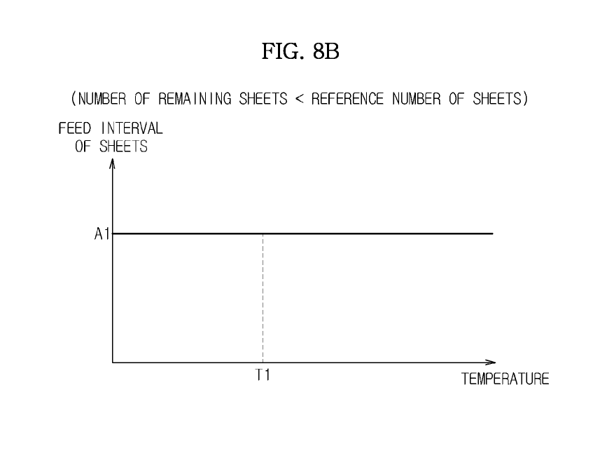

With reference to FIGS. 8A-8B, another exemplary embodiment of the image forming apparatus 1 is illustrated. More specifically, FIG. 8 illustrates that when the internal temperature of the image forming apparatus 1 is more than the designated temperature T1 and the number of remaining sheets of the recording media is smaller than the reference number of sheets, the image forming apparatus 1 does not enter the apparatus protection mode. When the image forming apparatus 1 does not enter the apparatus protection mode, the image forming apparatus 1 maintains the high printing velocity V1.

With reference to FIG. 8B, when the internal temperature of the image forming apparatus 1 is more than the designated temperature T1 and the number of remaining sheets of the recording media is smaller than the reference number of sheets, the image forming apparatus 1 does not enter the apparatus protection mode. When the image forming apparatus 1 does not enter the apparatus protection mode, the image forming apparatus 1 maintains the recording medium feed interval A1.

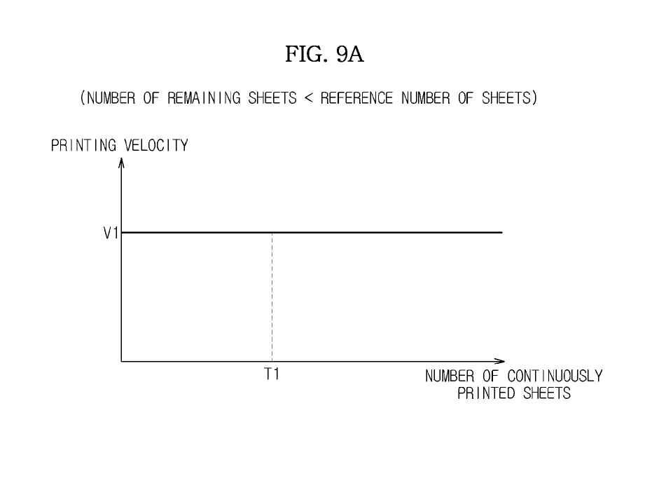

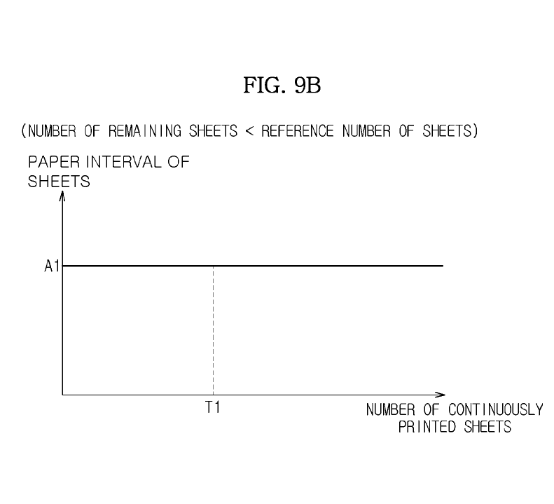

Referring now to FIGS. 9A-9B, another exemplary embodiment of the image forming apparatus 1 is illustrated. More specifically, FIG. 9A illustrates that when the number of continuously printed sheets is more than the designated number of sheets L1 and the number of remaining sheets of the recording media is smaller than the reference number of sheets, the image forming apparatus 1 does not enter the apparatus protection mode. When the image forming apparatus 1 does not enter the apparatus protection mode, the image forming apparatus 1 maintains the high printing velocity V1.

With reference to FIG. 9B, when the number of continuously printed sheets is more than the designated number of sheets L1 and the number of remaining sheets of the recording media is smaller than the reference number of sheets, the image forming apparatus 1 does not enter the apparatus protection mode. When the image forming apparatus 1 does not enter the apparatus protection mode, the image forming apparatus 1 maintains the recording medium feed interval A1.

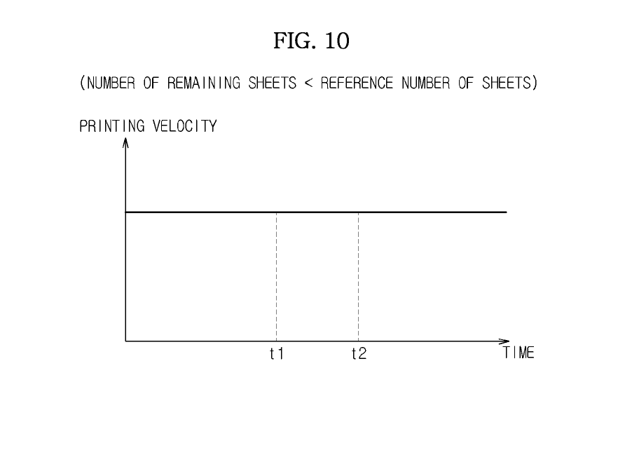

With reference to FIG. 10, yet another exemplary embodiment of the image forming apparatus is illustrated. Referring to FIG. 10, when the internal temperature of the image forming apparatus 1 is more than the designated temperature or the number of continuously printed sheets is more than the designated number of sheets, and the number of remaining sheets of the recording media is smaller than the reference number of sheets, the image forming apparatus 1 does not enter the apparatus protection mode. When the image forming apparatus 1 does not enter the apparatus protection mode, the printing operation is continuously executed without an operation stopping section.

The control unit 160 may control entry of the image forming apparatus 1 into the apparatus protection mode in consideration of the operation environment information transmitted from the operation environment detection unit 140, in addition to the temperature information of the image forming apparatus 1 transmitted from the temperature sensing unit 150.

The control unit 160 delays determination to entry into the apparatus protection mode, if the temperature of the image forming apparatus 1 transmitted from the temperature sensing unit 150 is a temperature at which the image forming apparatus 1 enters the apparatus protection mode but the operation environment of the image forming apparatus 1 transmitted from the operation environment detection unit 140 is in a low-temperature and low-humidity state (L/L). The control unit 160 may change a reference temperature to enter the apparatus protection mode in consideration of the predetermined internal temperature of the image forming apparatus 1 and temperature/humidity information according to the operation environment. Further, reference temperatures to enter the apparatus protection mode in consideration of the predetermined internal temperature of the image forming apparatus 1 and the temperature/humidity information according to the operation environment are stored in a lookup table of the storage unit 120. For example, the lookup table may be set such that, when the operation environment is in a high-temperature and high-humidity state (H/H), the reference temperature to enter the apparatus protection mode is low, and when the operation environment is in a low-temperature and low-humidity state (L/L), the reference temperature to enter the apparatus protection mode is high.

The image engine unit 170 executes printing of a recording medium under the control of the control unit 160. The image engine unit 170 prints an image of a file transmitted from a host on the recording medium based on a printing option. The image engine unit 170 heats the recording medium to a proper temperature and applies pressure to the recording medium, thus fusing the image to the recording medium.

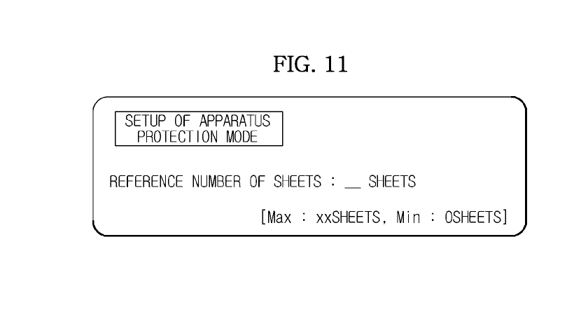

The display unit 180 may display an image to provide functions of the image forming apparatus 1. The display unit 180 may output a user interface screen allowing a user to set the apparatus protection mode entry condition. With reference to FIG. 11, a screen is output such that the user may input the reference number of sheets. In the screen, the maximum number of sheets and the minimum number of sheets. The maximum number of sheets and/or the minimum number of sheets may be input by the user, and may be displayed via the display unit 180. Accordingly, a designer may set a margin, enough not to cause fatal damage to the image forming apparatus 1 if printing is continuously executed from a point of time when it is determined that the image forming apparatus 1 enters the apparatus protection mode based on the internal temperature or the number of continuously printed sheets of the image forming apparatus 1, as the maximum number of sheets.

Further, the control unit 160 may change the maximum number of sheets. The control unit 160 may decrease the maximum number of sheets, if the accumulated number of continuously printed sheets is large and/or the internal temperature of the image forming apparatus 1 is higher than a designated temperature. The control unit 160 may increase the maximum number of sheets, if a print stand-by time is long and/or the internal temperature of the image forming apparatus 1 is lower than the designated temperature. The control unit 160 may change the maximum number of sheets according to the set lookup table. The lookup table may be stored in the storage unit 120, and the maximum number of sheets changed according to the accumulated number of continuously printed sheets and/or the temperature of the image forming apparatus 1 may be stored in the lookup table.

If the reference number of sheets input by the user is greater than the maximum number of sheets set by the designer, the maximum number of sheets is automatically set as the reference number of sheets. The minimum number of sheets may be set to “0”.

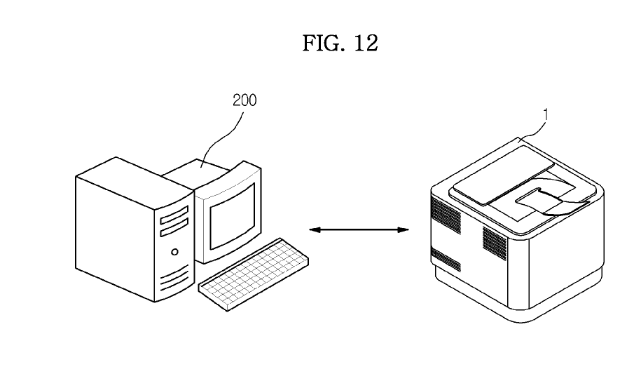

FIG. 12 is a view illustrating setup of an apparatus protection mode entry condition through a method using connection of the image forming apparatus in accordance with the exemplary embodiment of the present general inventive concept to a host, differing from the above-described method.

The image forming apparatus 1 is connected to a host 200. The host 200 includes, but is not limited to, a personal computer which transmits a file to be printed and a printing option to the image forming apparatus 1. A user may input the apparatus protection mode entry condition of the image forming apparatus 1 through the host 200.

The image forming apparatus 1 may execute printing according to the file and printing option transmitted from the host 200. The image forming apparatus 1 may receive the apparatus protection mode entry condition transmitted from the host 200 and store the apparatus protection mode entry condition in the storage unit 120.

The image forming apparatus 1 determines whether or not entry of the apparatus protection mode is executed according to at least one of the temperature of the image forming apparatus 1, the operation environment and the number of continuously printed sheets, and confirms from the host 200 whether the apparatus protection mode entry condition is satisfied. The apparatus protection mode entry condition transmitted from the host 200 may be the reference number of sheets. The image forming apparatus 1 enters the apparatus protection mode, if the number of remaining sheets is greater than the reference number of sheets at a point of time when the image forming apparatus 1 enters the apparatus protection mode, and does not enter the apparatus protection mode and continuously executes printing, if the number of remaining sheets is smaller than the reference number of sheets at this point of time.

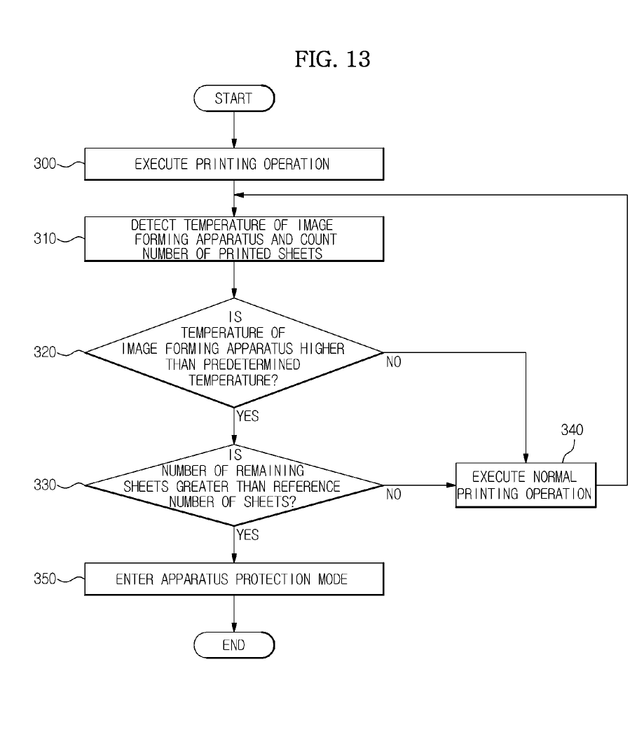

FIG. 13 is a flowchart illustrating an exemplary method of entering the apparatus protection mode of an image forming apparatus in accordance with one exemplary embodiment of the present general inventive concept of entering the apparatus protection mode.

When the image forming apparatus 1 receives a printing command from the host 200, the image forming apparatus 1 executes a printing operation (Operation 300).

The temperature sensing unit 150 detects the internal temperature of the image forming apparatus 1. The operation environment detection unit 140 detects the operation environment of the image forming apparatus 1. The operation environment may be information regarding temperature and/or humidity at the outside of the image forming apparatus 1. The printed sheet number count unit 130 determines the number of sheets, which are being actually printed. In at least one exemplary embodiment, the printed sheet number count unit 130 may determine the number of sheets actually printed by counting the number of driving times of the pickup roller 24 feeding the recording media, thus counting the number of printed sheets (Operations 310 and 320).

The control unit 160 determines whether or not the temperature of the image forming apparatus 1 is higher than a predetermined temperature. The temperature of the image forming apparatus 1 may be a temperature detected by the temperature sensing unit 150 or a temperature detected by the operation environment detection unit 140. In addition to the above temperatures, the temperature of the image forming apparatus 1 may be temperatures of various components installed in the image forming apparatus 1. The predetermined temperature is stored in advance in the storage unit 120 (Operation 320).

The control unit 160 determines the number of remaining sheets, if the temperature of the image forming apparatus 1 is higher than the predetermined temperature. The number of remaining sheets may be determined by subtracting the number of printed sheets, transmitted from the printed sheet number count unit 130, from the total number of sheets to be printed. The control unit 160 compares the number of remaining sheets with the reference number of sheets, and allows the image forming apparatus 1 to enter the apparatus protection mode, if the number of remaining sheets is greater than the reference number of sheets (Operations 330 and 350).

The control unit 160 executes the normal printing operation, if the temperature of the image forming apparatus 1 is higher than the predetermined temperature but the number of remaining sheets is smaller than the reference number of sheets (Operation 340).

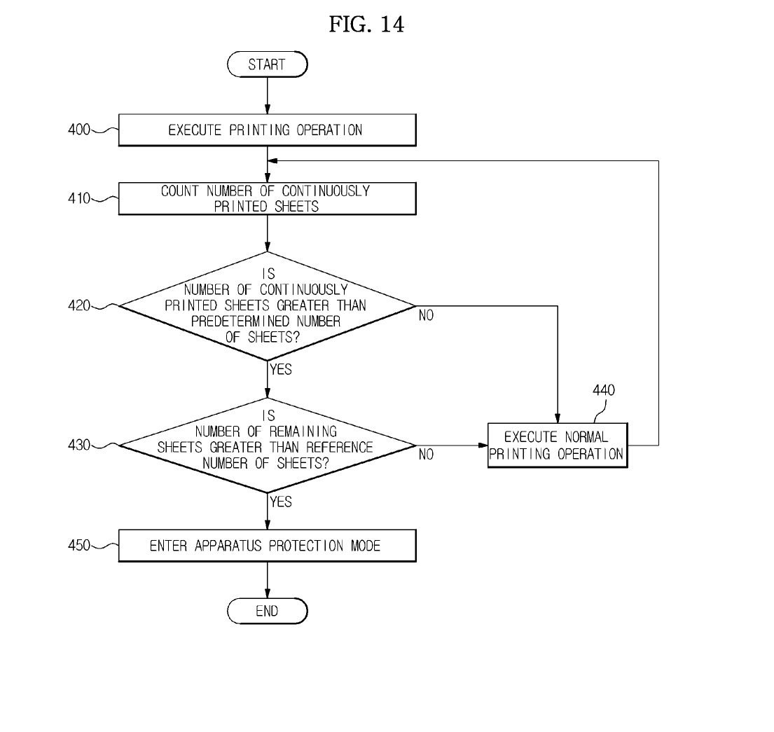

FIG. 14 is a flowchart illustrating a process of entering the apparatus protection mode of an image forming apparatus in accordance with another exemplary embodiment of the present general inventive concept.

When the image forming apparatus 1 receives a printing command from the host 200, the image forming apparatus 1 executes a printing operation (Operation 400).

The printed sheet number count unit 130 determines the number of printed sheets. The control unit 160 regards printing as continuous printing, if a time interval between the counted printed sheets is within a designated time (Operation 410).

The control unit 160 determines whether or not the number of continuously printed sheets is greater than the predetermined number of sheets (Operation 420).

The control unit 160 judges the number of remaining sheets, if the number of continuously printed sheets is greater than the predetermined number of sheets. The control unit 160 compares the number of remaining sheets with the reference number of sheets, and allows the image forming apparatus 1 to enter the apparatus protection mode, if the number of remaining sheets is greater than the reference number of sheets (Operations 430 and 450).

The control unit 160 executes the normal printing operation, if the number of continuously printed sheets is greater than the predetermined number of sheets but the number of remaining sheets is smaller than the reference number of sheets (Operation 440).

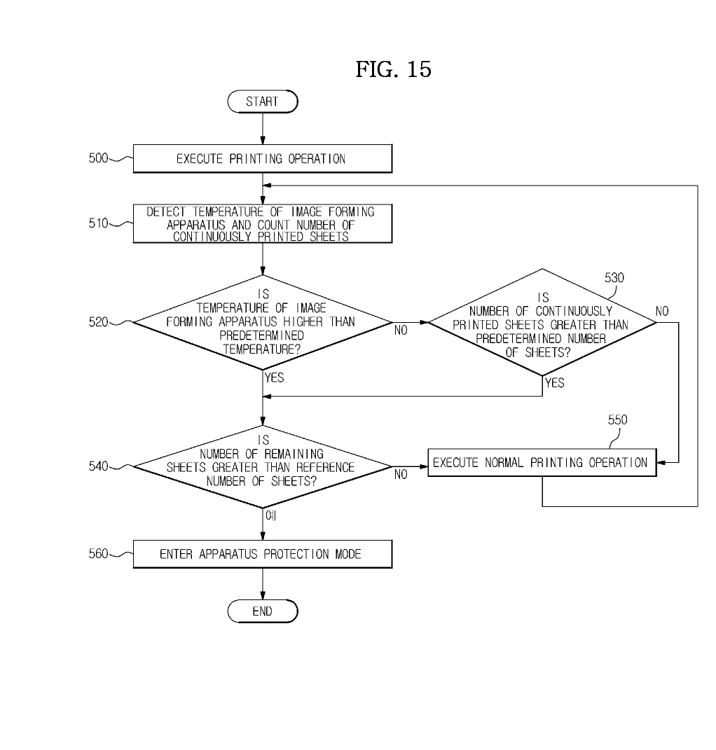

FIG. 15 is a flowchart illustrating a process of entering the apparatus protection mode of an image forming apparatus in accordance with yet another exemplary embodiment of the present general inventive concept.

When the image forming apparatus 1 receives a printing command from the host 200, the image forming apparatus 1 executes a printing operation (Operation 500).

The temperature sensing unit 150 detects the internal temperature of the image forming apparatus 1. The operation environment detection unit 140 detects the operation environment of the image forming apparatus 1. The operation environment may be information regarding temperature and humidity at the outside of the image forming apparatus 1. The printed sheet number count unit 130 determines the number of sheets, which are being actually printed (Operation 510).

The control unit 160 determines whether or not the temperature of the image forming apparatus 1 is higher than a predetermined temperature. The temperature of the image forming apparatus 1 may be an internal temperature detected by the temperature sensing unit 150 or an external temperature detected by the operation environment detection unit 140 (Operation 520).

The control unit 160 judges the number of remaining sheets, if the temperature of the image forming apparatus 1 is higher than the predetermined temperature. The control unit 160 compares the number of remaining sheets with the reference number of sheets, and allows the image forming apparatus 1 to enter the apparatus protection mode, if the number of remaining sheets is greater than the reference number of sheets (Operations 540 and 560).

The control unit 160 judges the number of continuously printed sheets, if the temperature of the image forming apparatus 1 is lower than the predetermined temperature. The control unit 160 compares the number of continuously printed sheets with the predetermined number of sheets. The control unit 160 compares the number of remaining sheets with the reference number of sheets, if the number of continuously printed sheets is greater than the predetermined number of sheets. The control unit 160 allows the image forming apparatus 1 to enter the apparatus protection mode, if the number of remaining sheets is greater than the reference number of sheets (Operations 530, 540 and 560).

The control unit 160 executes the normal printing operation, if the number of continuously printed sheets is smaller than the predetermined number of sheets in Operation 530. As described above, normal execution of printing of the image forming apparatus 1 means that the image forming apparatus 1 does not enter the apparatus protection mode but the basic printing operation of the image forming apparatus 1 is maintained (Operations 530 and 550).

As is apparent from the above description, an image forming apparatus in accordance with one exemplary embodiment of the present general inventive concept enters an apparatus protection mode in consideration of the number of remaining sheets of recording media, thereby providing an ideal temperature throughout the entire image forming apparatus, and thus increasing operation efficiency.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An image forming apparatus comprising:
an input unit to receive an apparatus protection mode entry condition of the image forming apparatus;
a temperature sensing unit to detect a temperature of the image forming apparatus;
a printed sheet count unit to count a number of continuously printed sheets; and
a control unit to judge whether or not the apparatus protection mode entry condition is satisfied, if the temperature of the image forming apparatus is higher than a predetermined temperature or the number of continuously printed sheets is greater than the predetermined number of sheets, and to maintain a basic printing operation of the image forming apparatus, if the apparatus protection mode entry condition is not satisfied.

2. The image forming apparatus according to claim 1, wherein the input unit receives the reference number of sheets of recording media which is compared with the number of remaining sheets of the recording media, as the apparatus protection mode entry condition.

3. The image forming apparatus according to claim 2, wherein the control unit judges whether or not the apparatus protection mode entry condition is satisfied by comparing the number of remaining sheets of the recording media with the reference number of sheets of the recording media received by the input unit, if the temperature of the image forming apparatus is higher than the predetermined temperature or the number of continuously printed sheets is greater than the predetermined number of sheets.

4. The image forming apparatus according to claim 1, wherein the temperature sensing unit senses the temperature of a random component provided within the image forming apparatus.

5. The image forming apparatus according to claim 1, further comprising an operation environment detection unit to detect operation environment including operation temperature and operation humidity information of the image forming apparatus.

6. The image forming apparatus according to claim 5, wherein the control unit determines a point of time when whether or not entry into an apparatus protection mode is determined according to the temperature of the image forming apparatus and the operation environment.

7. The image forming apparatus according to claim 1, wherein the control unit allows the image forming apparatus to enter an apparatus protection mode, if the temperature of the image forming apparatus is higher than the predetermined temperature or the number of continuously printed sheets is greater than the predetermined number of sheets, and the apparatus protection mode entry condition is satisfied.

8. The image forming apparatus according to claim 7, wherein the control unit reduces a printing velocity of the recording media, widens a feed interval of the recording media, or stops printing of the recording media and then re-executes printing of the recording media after a designated time, if the image forming apparatus enters the apparatus protection mode.

9. A control method of an image forming apparatus comprising:
receiving an apparatus protection mode entry condition of the image forming apparatus;
detecting at least one of a temperature of the image forming apparatus and a number of continuously printed sheets;
judging whether or not the apparatus protection mode entry condition is satisfied, if the temperature of the image forming apparatus is higher than a predetermined temperature or the number of continuously printed sheets is greater than the predetermined number of sheets; and
maintaining a basic printing operation of the image forming apparatus, if the apparatus protection mode entry condition is not satisfied.

10. The control method according to claim 9, wherein the receipt of the apparatus protection mode entry condition includes receiving the reference number of sheets of recording media which is compared with the number of remaining sheets of the recording media when whether or not entry into an apparatus protection mode is judged.

11. The control method according to claim 10, wherein whether or not the apparatus protection mode entry condition is satisfied is judged by comparing the number of remaining sheets of the recording media with the reference number of sheets of the recording media received as the apparatus protection mode entry condition by the input unit at a point of time when the temperature of the image forming apparatus is higher than the predetermined temperature or the number of continuously printed sheets is greater than the predetermined number of sheets.

12. The control method according to claim 9, further comprising detecting operation environment including operation temperature information of the image forming apparatus.

13. The control method according to claim 12, wherein a point of time when whether or not the apparatus protection mode entry condition is satisfied is judged is delayed, if the temperature of the image forming apparatus is higher than the predetermined temperature or the number of continuously printed sheets is greater than the predetermined number of sheets, and the operation temperature is lower than a predetermined temperature.

14. The control method according to claim 12, wherein a point of time when whether or not the apparatus protection mode entry condition is satisfied is judged is advanced, if the temperature of the image forming apparatus is lower than the predetermined temperature or the number of continuously printed sheets is smaller than the predetermined number of sheets, and the operation temperature is higher than a predetermined temperature.

15. The control method according to claim 9, wherein the image forming apparatus enters an apparatus protection mode, if the temperature of the image forming apparatus is higher than the predetermined temperature or the number of continuously printed sheets is greater than the predetermined number of sheets, and the apparatus protection mode entry condition is satisfied.

16. The control method according to claim 15, wherein a printing velocity of the recording media is reduced, a feed interval of the recording media is widened, or the printing operation of the recording media is stopped and then re-executed after a designated time, if the image forming apparatus enters the apparatus protection mode.

17. An image forming apparatus to output printed media, comprising:
a temperature sensing unit to detect a temperature of the image forming apparatus;
a printed sheet count unit to determine a number of continuously printed media; and
a control unit to determine existence of a protection mode condition based on the temperature and the number of continuously printed media, and to initiate a protection mode that cools the image forming apparatus when the protection mode condition exists.

18. The image forming apparatus of claim 17, wherein the control unit maintains a basic printing operation of the image forming apparatus when the apparatus protection mode condition is does not exist.

19. The image forming apparatus of claim 17, wherein the protection mode condition includes at least one of the temperature of the image forming apparatus being higher than a predetermined temperature, and the number of continuously printed media being greater than a predetermined number of sheets, and a number of media awaiting printing completion.

20. The image forming apparatus of claim 17, further comprising an input unit to input the protection mode condition.

21. The image forming apparatus of claim 20, wherein the input unit inputs at least one of a value indicating a predetermined temperature and a value indicating a predetermined number of sheets.

22. An image forming apparatus to generate recorded media having images formed thereon, comprising:
a printed sheet count unit to determine a number of completed printed media continuously output from the image forming apparatus; and
a control unit to determine an amount of remaining medium awaiting printing based on the number of completed printed media, and to initiate a protection mode that prevents overheating of the image forming apparatus based on the amount of remaining medium.

23. The image forming apparatus of claim 22, further comprising a transfer unit to convey the printed media at a diving velocity in response to a velocity signal output by the control unit.

24. The image forming apparatus of claim 23, wherein the control unit outputs a low velocity signal that commands the transfer unit to decrease the driving velocity in response to initiating the protection mode.

25. The image forming apparatus of claim 23, further comprising a temperature sensing unit in electrical communication with the control unit to detect an operating temperature of the image forming apparatus, the control unit comparing the operating temperature with a predetermined reference temperature and initiating the protection mode when the operating temperature exceeds the predetermined reference temperature and the amount of remaining medium exceeds a remaining reference value.

26. The image forming apparatus of claim 25, wherein the control unit outputs a low velocity signal that commands the transfer unit to decrease the driving velocity in response to initiating the protection mode.

27. An image forming apparatus, comprising:
a transfer unit that drives a transfer belt at a driving velocity;
a temperature sensing unit to detect a temperature of the image forming apparatus;
a printed sheet count unit to determine a number of continuously printed media; and
a control unit in electrical communication with the transfer unit, the temperature sensing unit and the printed sheet count unit to determine an apparatus protection condition based on the temperature and the number of continuously printed media, and to selectively operate the image forming apparatus in a normal mode and a protection mode based on the apparatus protection condition, the transfer unit driving the transfer belt at a first driving velocity during the normal mode and a second driving velocity that is slower than the first driving velocity during the protection mode.

28. The image forming apparatus of claim 27, wherein the control unit operates the image forming apparatus in the protection mode when the apparatus protection condition exists, and operates the image forming apparatus in the normal mode when the apparatus protection condition does not exist.

29. The image forming apparatus of claim 28, wherein the control unit determines the apparatus protection condition exists when the temperature exceeds a predetermined reference temperature and a number of remaining printed media awaiting printing exceeds a predetermined value.
